(19) United States
(12) Patent Application Publication
(10) Pub. No.: US 2025/0020684 A1
(43) Pub. Date: Jan. 16, 2025

(54) GRADIENT ULTRACENTRIFUGATION AUTOMATED COLLECTOR

(71) Applicant: AAVANTIBIO, INC., Charlestown, MA (US)

(72) Inventor: Matthew BURG, Gainesville, FL (US)

(21) Appl. No.: 18/903,962

(22) Filed: Oct. 1, 2024

Related U.S. Application Data
(63) Continuation of application No. PCT/US2023/017628, filed on Apr. 5, 2023.
(60) Provisional application No. 63/362,489, filed on Apr. 5, 2022.

(51) Int. Cl. G01N 35/10; B04B 5/04

(52) U.S. Cl. CPC G01N 35/1016; B04B 5/0414

(57) ABSTRACT

The present disclosure relates to a modified liquid handling system and related methods for collecting, separating, dispensing or otherwise conveying liquids, including a selected desired portion of a liquid sample, to a desired location. Several embodiments provided for herein relate to extraction of material of interest from layered, gradated, or partitioned, samples.

### RELATED APPLICATIONS

This application is a continuation of PCT Application No. PCT/US2023/017628, filed on Apr. 5, 2023, which claims the benefit of U.S. Provisional Application No. 63/362,489, filed on Apr. 5, 2022, each of which is hereby incorporated by reference herein in its entirety.

### FIELD

The embodiments described herein generally relate to an improved process for the identification and extraction of material of interest from layered, gradated, or partitioned samples.

### BACKGROUND

Unit operations involved in the processing of collected biological samples involve the preferential separation of desirable and undesirable molecular species. In particular, gradient separation allows for preferential partition of certain species based on inherent physiochemical properties. Optimization of unit operations at this step may increase overall purity, yield, and reduce processing time.

### SUMMARY

Current methods, processes, and machines for extraction of material of interest from samples that have been layered, gradated, or partitioned by ultracentrifugation are highly labor intensive. Lack of automation of these methods, processes, and machines increase inconsistency, operator variability, and the potential for product contamination. When manually performed, an operator extracting a material of interest from a sample that has been layered, gradated, or partitioned by ultracentrifugation must visually inspect the sample in order to determine the boundary conditions and specific layer, gradation, or partition the material of interest resides in, and finally, must extract the material from only the layer, gradation, or partition of interest. Repeating this process across a large sample set may introduce repeatability issues, measurement errors, and the possibility of cross-contamination of samples. Further, some regulatory compliance rules when formulating compounds for pharmaceutical use may require lower rates of error and cross-contamination than can be readily provided when using manual methods.

With repeatability issues plaguing current labor-intensive methods, processes, and machines for extraction of material of interest from a layered, gradated, or partitioned sample, there has been limited progress in moving manufacturing processes towards certain regulatory compliance. Therefore, the present disclosure aims to move highly labor intensive manufacturing processes towards regulatory compliance while increasing consistency, reducing operator variability, and decreasing the potential for product contamination.

Provided herein are methods and systems relating to separating a product.

Accordingly disclosed herein is an automated liquid handling system. In some embodiments, the liquid handling system comprises an imaging station and a collection apparatus. In some embodiments, the automated liquid handling system, comprises an imaging station, a collection apparatus, and a control computer. In some embodiments, the imaging station is configured to image a sample and transmit a sample image to a control computer. In some embodiments, the imaging station and the collection apparatus are operably linked to the control computer. In some embodiments, the imaging station, collection apparatus, and/or control computer are operably connected via a wired connection. In some embodiments, the imaging station, collection apparatus, and/or control computer are operably connected via a wireless connection. In some embodiments, the sample image is transmitted to the control computer via a wired connection. In some embodiments, the sample image is transmitted to the control computer wirelessly. In some embodiments, the control computer is configured to process the sample image. In some embodiments, the control computer is configured to direct the collection apparatus to transfer a defined extraction volume from the sample to a sample collection vessel. In some embodiments, the control computer is configured to automatically calculate the defined extraction volume. In some embodiments, an operator defines the extraction volume. In some embodiments, the automated liquid handling system, comprises an imaging station, a collection apparatus, and a control computer.

In some embodiments, the imaging station and collection apparatus are standalone components. In some embodiments, the imaging station and collection apparatus are integrated into a single system. In some embodiments, one or more of the imaging station, collection apparatus, and control computer are standalone components. In some embodiments, one or more of the imaging station, collection apparatus, and control computer are integrated into a single system. In some embodiments, the imaging station comprises a sample storage apparatus, a light source, and an imaging device. In some embodiments, the sample storage apparatus, light source, and imaging device are integrated into a single imaging station. In some embodiments, the automated liquid handling system further comprises a graphical user interface or monitor that is operably linked to the control computer. In some embodiments, one or more of the imaging station, collection apparatus, collection vessel, control computer, or graphical user interface or monitor are integrated into a single functional system.

In some embodiments, the imaging device comprises a camera. In some embodiments, the sample storage apparatus comprises a tube rack. In some embodiments, the sample storage apparatus comprises a multi-well plate rack. In some embodiments, the sample storage apparatus has a specific opacity. In some embodiments, the light source corresponds to the specific opacity of the sample storage apparatus. In some embodiments, the light source is located above, below, or oblique to the sample storage apparatus. In some embodiments, the light source is located above the sample storage apparatus. In some embodiments, the light source is located below the sample storage apparatus. In some embodiments, the light source is located oblique to the sample storage apparatus. In some embodiments, the light source, light source position, and sample storage apparatus opacity are collectively chosen for their combined suitability for imaging samples contained in the sample storage apparatus.

In some embodiments, a collection apparatus comprises a collection arm and a collection device. In some embodiments, the collection device is removably attached to the collection arm. In some embodiments, the collection arm is configured such that it may be directed by the control computer to move in 3 dimensions, including the x, y, and z directions. In some embodiments, the control computer directs movement of the collection device laterally, horizontally, and/or vertically along a collection arm. In some embodiments, the control computer directs movement of the control arm vertically on its y axis. In some embodiments, the control computer directs movement of the control arm laterally on its x axis. In some embodiments, the light source is integrated into the collection arm. In some embodiments, the control computer directs the control arm to position the collection device at predetermined extraction coordinates.

In some embodiments, the collection device comprises means for sample transfer from the sample storage apparatus to the sample collection vessel. In some embodiments, the collection device comprises a pipette. In some embodiments, the collection device comprises a needle and syringe. In some embodiments, the collection device comprises a vacuum. In some embodiments, the automated liquid handling system further comprises a tip rack. In some embodiments, the automated liquid handling system further comprises a tip disposal vessel.

In some embodiments, a method for automated extraction of material from a sample is disclosed. In some embodiments, the method for automated extraction of material from a sample is disclosed comprises loading a sample onto an imaging station, illuminating the sample, imaging the illuminated sample, transmitting a sample image to a control computer, calculating an extraction volume and extraction coordinates based on the sample image, directing a collection arm to orient a collection device at the calculated extraction coordinates, aspirating a calculated extraction volume from the sample into the collection device, directing the collection arm to orient the collection device to a collection vessel that is located at predetermined coordinates, and dispensing an extracted volume into the collection vessel. In some embodiments, the method for automated extraction of material from a sample further comprises repeating the preceding steps for each of n samples; wherein n is a non-negative integer.

In some embodiments, the method for automated extraction of material from a sample, comprises loading one or more sample(s) onto an imaging station, illuminating the one or more sample(s) to generate one or more illuminated sample(s), imaging the one or more illuminated sample(s), transmitting one or more sample image(s) to a control computer, calculating an extraction volume and extraction coordinates based on the sample image, directing a collection arm to orient a collection device at the calculated extraction coordinates, aspirating the calculated extraction volume from the one or more sample(s) into a collection device, directing the collection arm to orient the collection device to one or more collection vessel(s), and dispensing the extraction volume into the one or more collection vessel(s). In some embodiments, the method for automated extraction of material from a sample, further comprising repeating steps the preceding for each sample within the one or more sample(s). The method of any of the previous Claims, further comprising acquiring a pipette tip prior to sample aspiration.

In some embodiments, the method for automated extraction of material from a sample further comprises discarding used tips following dispensation of the extracted sample volume into the collection device.

In some embodiments, calculating an extraction volume and extraction coordinates based on the sample image comprises defining an extraction boundary. In some embodiments, defining the extraction boundary is performed by the control computer. In some embodiments, the extraction boundary is defined by an operator. In some embodiments, the operator is a computer program. In some embodiments, the operator is a human.

In some embodiments, the method for automated extraction of material from a sample further comprises centrifuging the sample prior to loading onto the imaging station. In some embodiments, the sample comprises a layered, gradated, or partitioned sample. In some embodiments, the extracted material comprises one layer, gradation, or partition of a layered, gradated, or partitioned sample. In some embodiments, the method for automated extraction of material from a sample further comprises the one or more sample(s) prior to loading. In some embodiments, the one or more sample(s) comprises a layered, gradated, or partitioned sample. In some embodiments, the extracted material comprises one layer, gradation, or partition of a layered, gradated, or partitioned sample.

### BRIEF DESCRIPTION OF THE DRAWINGS

FIG. 1 is a schematic diagram of a non-limiting example of a modified liquid handler.

FIG. 2 illustrates a flow chart of a non-limiting example process for automated extraction of material from layered, gradated, or partitioned samples.

FIG. 3 is schematic of a non-limiting embodiment of a computing system configured to control one or more aspects of the liquid handling system disclosed herein.

FIG. 4 is a non-limiting example of an image showing some embodiments of setpoints close to the desired extraction band (left) and the results of extraction at high aspiration rates (right).

FIG. 5 is a non-limiting example of an image showing some embodiments of setpoints lower and higher than the desired extraction band (left) and the results of extraction at slow aspiration rates (right).

FIG. 6 is a table showing some embodiments of capsid recovery from tubes with different set heights and aspiration rates.

FIG. 7 is a non-limiting example of an image showing some embodiments of set points (left) and recovery (right).

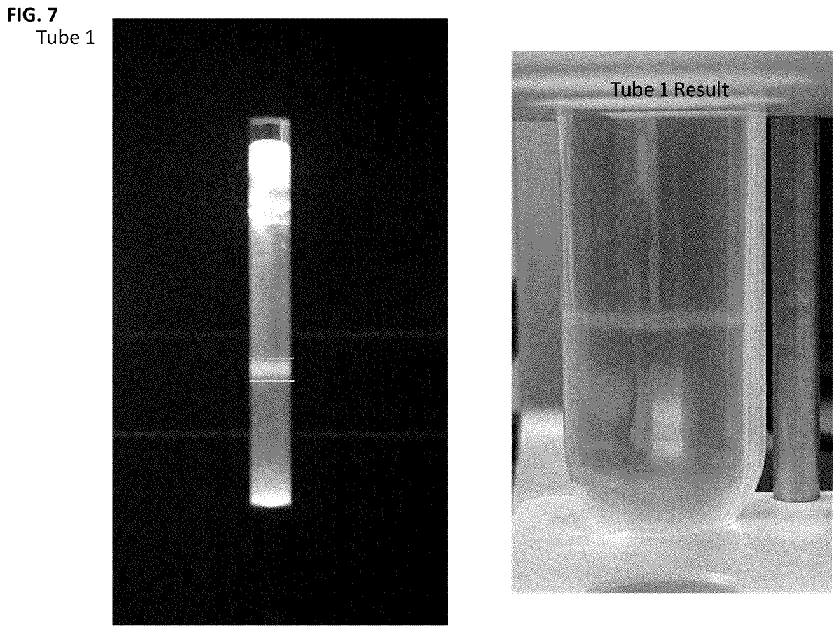

FIG. 8 is a non-limiting example of an image showing some embodiments of set points (left) and recovery (right).

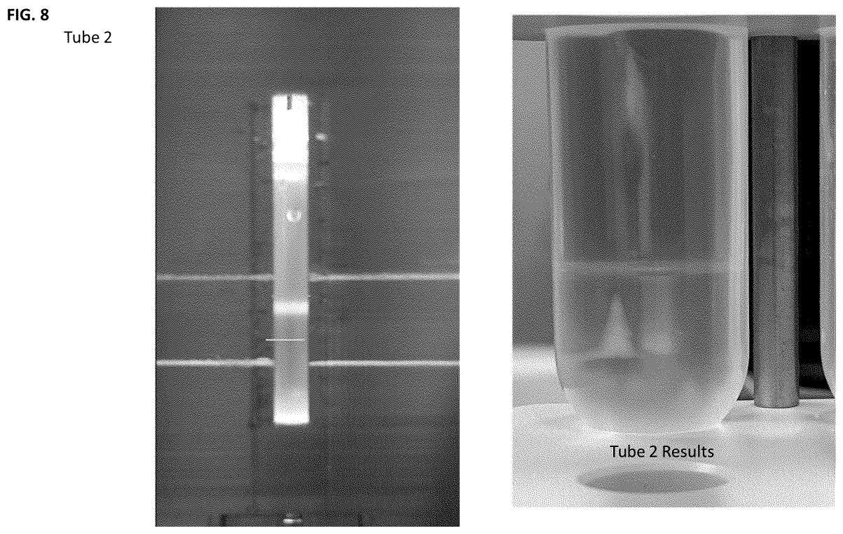

FIG. 9 is a non-limiting example of an image showing some embodiments of set points (left) and recovery (right).

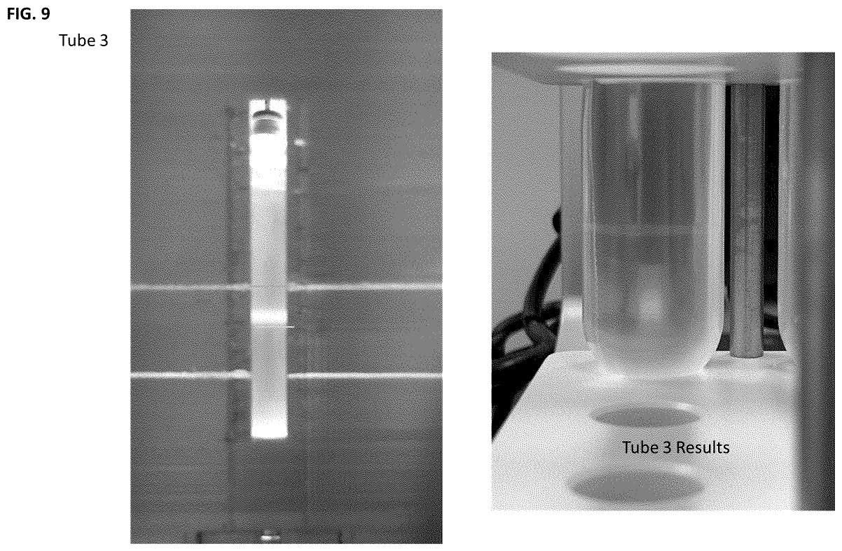

FIG. 10 is a non-limiting example of an image showing some embodiments of set points.

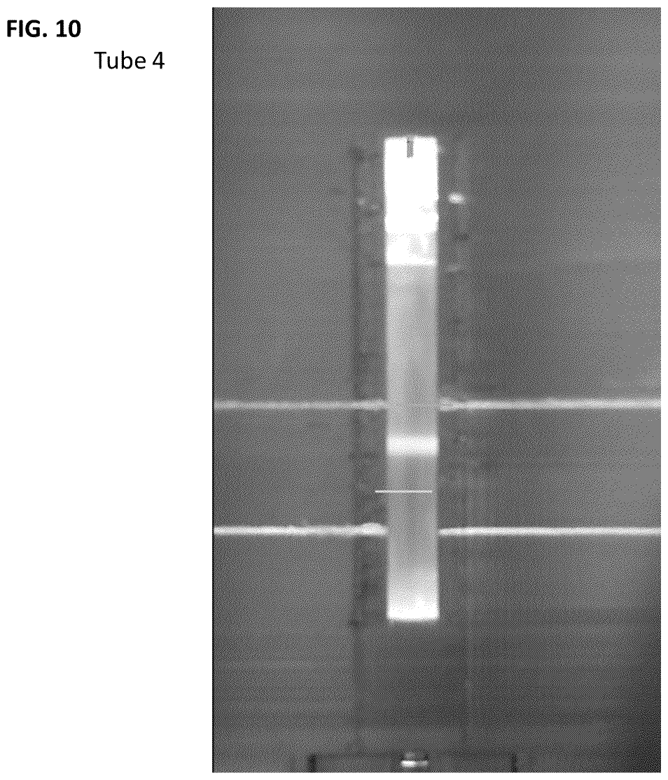

FIG. 11 is a non-limiting example of an image showing some embodiments of set points (left) and recovery (right).

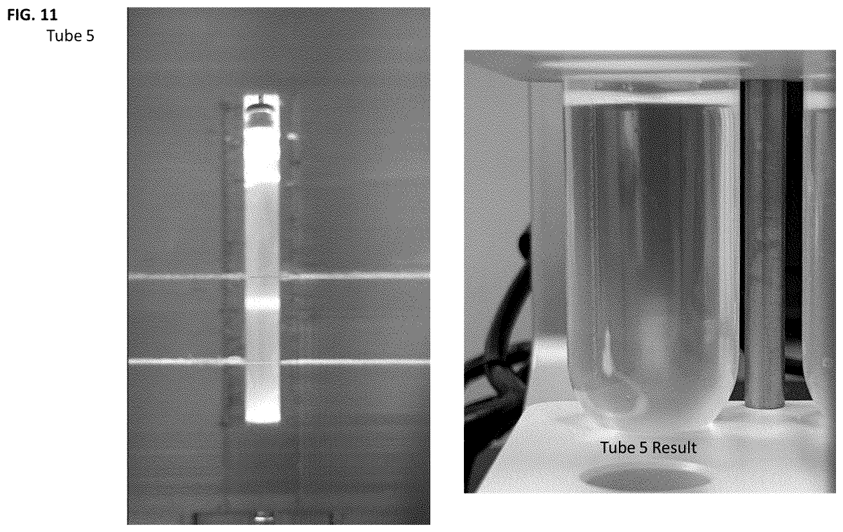

FIG. 12 is a non-limiting example of an image showing some embodiments of set points (left) and recovery (right).

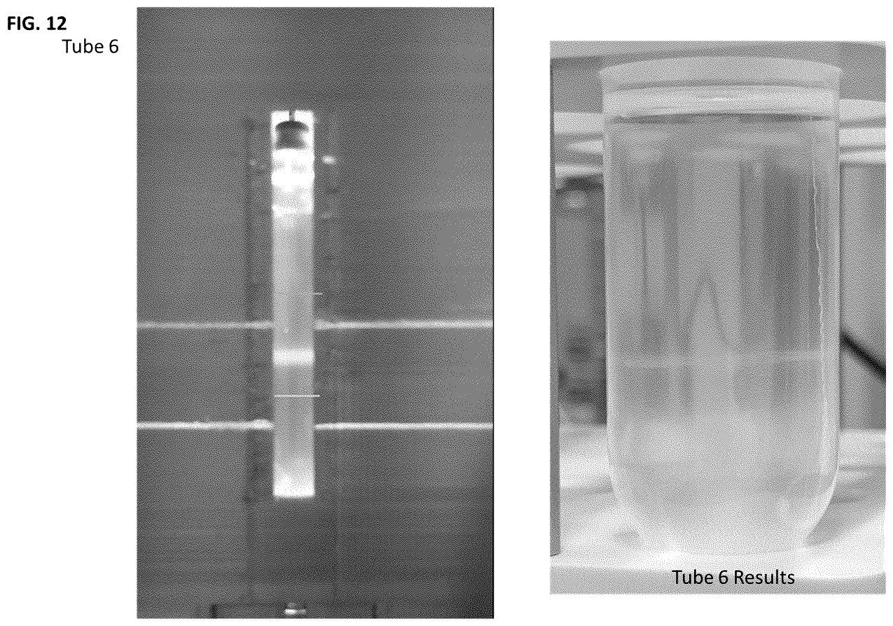

FIG. 13 is a non-limiting example of an image showing some embodiments of set points (left) and recovery (right).

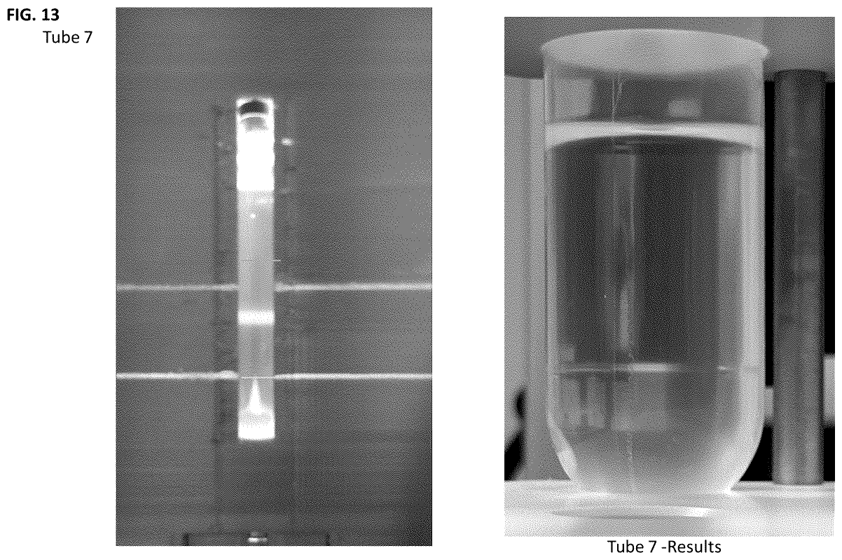

FIG. 14 is a non-limiting example of an image showing some embodiments of set points (left) and recovery (right).

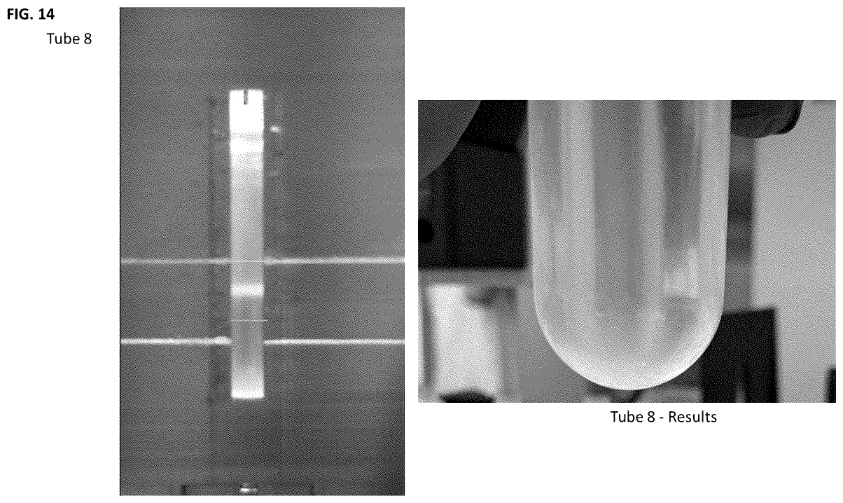

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the presently disclosed invention is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain embodiments herein are described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting embodiments and that the scope of the present invention is defined solely by the claims. The features illustrated or described in connection with one embodiment may be combined with the features of other embodiments. Such modifications and variations are intended to be included within the scope of the present technology.

Current methods for the identification and extraction of material of interest from samples layered, gradated, or partitioned via centrifugation, i.e., gradient ultracentrifugation, are limited by the requirement for an operator who must visually inspect each sample to determine the location of the desired density gradient separated material; such as DNA-containing viral particles from empty particles. Material is then manually extracted from the layered, gradated, or partitioned sample using means such as a needle and syringe, or pipette. To extract the material of interest, the operator must manually force a needle through the wall of the centrifuge tube into the identified layer, gradation, or partition of interest. Material is then extracted into the syringe for further processing. The operator must manually repeat this process for each sample. In other methods, such as CsCl gradients, the refractive index of the density gradient can be used to separate out the desired material by density. This refractive index can be compared to a reference range of refractive indexes wherein the desired materials are located. The gradient may then be separated into parts based on the refractive index cutoffs by using a blunt end needle connected to a syringe with the needle positioned at the bottom of the centrifuge tube. The material of interest may then be extracted into the syringe for further processing.

Current methods, processes, and machines for extraction of material of interest from a layered, gradated, or partitioned, sample are highly manual. Lack of automation of these methods, processes, and machines increase inconsistency, increase the likelihood for operator error, operator variability, and increase the potential for product contamination. Some embodiments herein are directed to a modified, computerized, liquid handling device that automates the process of material extraction. Some embodiments herein are methods and systems relating to separating a product.

Some embodiments herein are directed to an automated (e.g., robotic) method for collection of a desired fraction(s) from the ultracentrifugation tubes. In some embodiments, one or more tubes are inoculated with the same viral load, each of the one or more tubes having the same CsCl concentration. The one or more tubes then subjected to the same centrifugation, or spin, parameters with the resulting band separation identical, or substantially identical, in each of the one or more tubes. Accordingly, a single tube may be used to set an exact collection point and volume for extraction of the desired material. This extraction can then be repeated for each subsequent tube. The speed and reproducibility allow for an automated collection process to remove the current industry bottleneck and increase product quality in the manufacture of gene therapy products.

Provided herein are methods and systems relating to separating a product, such as, for example a desired portion of a liquid product from a non-desired portion.

In some embodiments, an automated liquid handling system is disclosed, the liquid handling system comprising: an imaging station and a collection apparatus that are operably linked to a control computer; wherein, an image of a sample is captured and transmitted from the imaging station to the operably linked control computer; wherein the control computer processes one or more sample images; and directs a collection apparatus to transfer a defined extraction volume from a particular location within one or more of n samples to a sample collection vessel.

In some embodiments, an imaging station comprises a sample storage apparatus, a light source, and an imaging device. In some embodiments, the imaging device comprises a camera. In some embodiments, the sample storage apparatus comprises a tube rack. In some embodiments, the sample storage apparatus comprises a multi-well plate rack. In some embodiments, the opacity of a sample storage apparatus is chosen for its use in imaging a sample that is illuminated by a specific light source. In some embodiments, a light source is chosen for its use in imaging a sample that is contained in a sample storage apparatus of a given opacity. In some embodiments, a light source is located below a sample storage apparatus.

In some embodiments, the disclosed system further comprises a graphical user interface or monitor operably linked to a control computer. In some embodiments, a collection apparatus comprises a collection arm and a collection device. In some embodiments, a collection device is removably attached to a collection arm. In some embodiments, a collection arm further comprises mechanical means for allowing a collection device to move laterally along the collection arm.

In some embodiments, a control computer directs movement of a collection device laterally along a collection arm. In some embodiments, a collection arm is configured such that it may be directed by a control computer to move in the x, y, and z directions. In some embodiments, a control computer directs a control arm to position a collection device at predetermined extraction coordinates. In some embodiments, the collection device comprises a pipette. In some embodiments, the collection device comprises a needle and syringe. In some embodiments, one or more of the imaging station, collection apparatus, collection vessel, or control computer are integrated into a single functional unit. In some embodiments, the disclosed system further comprises a tip rack. In some embodiments, the disclosed system further comprises a tip disposal vessel.

In some embodiments, a method for automated extraction of material from a sample is disclosed, the method comprising: a. loading n samples onto an imaging station, b. illuminating a sample, c. imaging an illuminated sample, d. transmitting one or more sample images to a control computer, c. displaying one or more sample images to an operator; wherein an operator defines an extraction boundary, f. calculating an extraction volume and extraction coordinates based on the defined extraction boundary, g. directing a collection arm to orient a collection device at the calculated extraction coordinates, h. aspirating a calculated extraction volume from a sample into a collection device, i. directing a collection arm to orient a collection device at an appropriate depth in a collection vessel that is located at predetermined coordinates, j. dispensing an extracted volume into a collection vessel, k. repeating steps b through j for each of n samples, and l. directing a control arm to orient a collection device in a predetermined home position.

In some embodiments, the disclosed method further comprises centrifuging n samples prior to loading n samples onto an imaging station. In some embodiments, one or more of n sample comprises a layered, gradated, or partitioned sample. In some embodiments, the extracted material comprises one layer, gradation, or partition of a layered, gradated, or partitioned sample.

In some embodiments, a method for automated extraction of material from a sample is disclosed, the method comprising: a. loading n samples onto an imaging station, b. illuminating a sample, c. imaging an illuminated sample, d. transmitting one or more sample images to a control computer, e. displaying one or more sample images to an operator; wherein f. an operator defines an extraction boundary, g. calculating an extraction volume and extraction coordinates based on the defined extraction boundary, directing a collection arm to orient a collection device above a tip in a tip rack that is located at predefined coordinates, directing a collection device to pick up a tip on a first end of the collection device, j. directing a collection arm to orient a collection device at the determined extraction coordinates, k. aspirating a calculated extraction volume from a sample into a collection device, l. directing a collection arm to orient a collection device at an appropriate depth in a collection vessel that is located at predetermined coordinates, m. dispensing an extracted volume into a collection vessel, n. directing a collection arm to orient a first end of a tipped collection device at appropriate coordinates for tip disposal above or within a tip disposal vessel that is located at predetermined coordinates, o. directing a collection device to dispense a used tip into a tip disposal vessel, p. repeating steps b through o for each sample in n samples, and q. directing a collection arm to orient a collection device in a predetermined home position.

In some embodiments, the method further comprises centrifuging n samples prior to loading the samples onto an imaging station. In some embodiments, a sample comprises a layered, gradated, or partitioned sample. In some embodiments, extracted material comprises one layered, gradated, or partitioned of a layered, gradated, or partitioned sample.

### Automated Liquid Handling Device

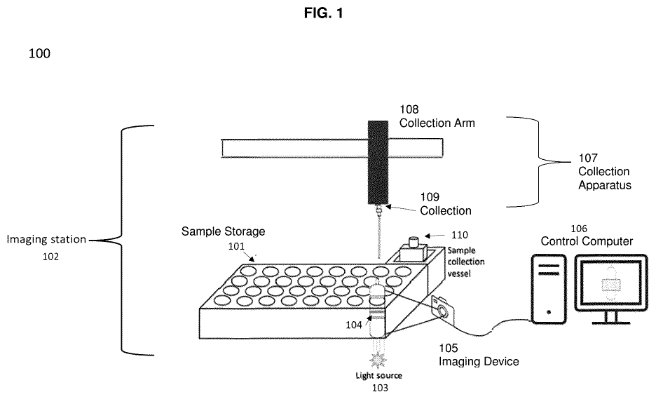

FIG. 1 is a schematic diagram of a non-limiting example of a modified liquid handler.

Currently, methods of extracting material of interest from layered, gradated, partitioned, or otherwise separated or divided samples are labor intensive. An automated liquid handling device 100 is provided. An operator fills a sample storage apparatus, e.g., a tube rack, 101 in an imaging station 102 with samples. In some embodiments, the centrifuge tubes are collected post ultracentrifugation, e.g., gradient ultracentrifugation. In some embodiments, the sample storage apparatus is clear. In some embodiments, the sample storage apparatus is opaque. The sample storage apparatus has an opacity selected for use with a desired light source 103. In some embodiments, sample storage apparatus opacity is selected for its suitability for use in imaging layered, gradated, or partitioned samples 104 contained in a tube within said sample storage apparatus. In some embodiments, the imaging station 102 comprises a single tube rack. In some embodiments, the imaging station comprises multiple tube racks. In some embodiments, the tube racks comprise means for containing, i.e., securing, tubes of a consistent size within the imaging station. In some embodiments, the tube racks comprise means for containing, i.e., securing, tubes of various sizes within the imaging station. In some embodiments, the imaging station comprises a multiwell plate rack. In some embodiments, the imaging station comprises both tube racks and multiwell plate racks. In some embodiments, the multiwell plates have 2 or more wells. In some embodiments, the multiwell plates are 6, 12, 24, 48, 96, 384, 1536 well plates. In some embodiments, the multiwell plates are deep-well plates.

In a preferred embodiment, the tubes are ultracentrifuge tubes. In some embodiments the tubes are microcentrifuge tubes, specialty microcentrifuge tubes, screw cap micro tubes, microtiter tubes, Eppendorf tubes, Falcon tubes, PCR tubes, or other suitable tubes. Suitable tubes for use in the present disclosure can be of any size. For example, the tubes can be 250 μL, 400 μL, 500 μL, 1 mL, 1.2 mL, 1.5 mL, 2 mL, 5 mL, 10 mL, 14 mL, 15 mL, 25 mL, 50 mL, 250 mL, and any volume up to 250 mL, or greater than 250 mL. In some embodiments, the tubes are 50 mL tubes. In several embodiments, the tubes are clear. In some embodiments, the tubes have an opacity selected for use with a desired light source and tube rack that is sufficient to allow imaging of a layered, gradated, or partitioned sample contained in an ultracentrifuge tube secured within said tube rack. In some embodiments, the ultracentrifuge tubes have caps. In some embodiments, the operator opens the tube by removing, unscrewing, or otherwise displacing the ultracentrifuge cap. In some embodiments, the tubes have no caps.

In some embodiments, the light source is integrated into a sample storage apparatus. In some embodiments, the light source is integrated into an imaging station. In some embodiments, a light source, sample storage apparatus, and imaging station are integrated into a single unit. In several embodiments, a light source illuminates a sample from beneath the sample. In some embodiments, a light source illuminates a sample from the side of the sample, from above the sample, or at an angle to the sample. In some embodiments, the light source comprises an LED light source. In some embodiments, the light source comprises a strip, or other shape, (e.g., a plurality of) of LED light sources. In some embodiments, a light source illuminates a sample continuously. In some embodiments, a light source illuminates a sample intermittently. In some embodiments, the intensity of the light source is or can be adjustable. For example, in some embodiments, the intensity of a light source may be adjusted to emit light at an intensity of about 1, 2, 3, 4, 5, 6, 7, 8, 9, 10, 20, 25, 30, 40, 50, 60, 70, 75, 80, 90, 95, or 100%, of the maximum intensity of the light source, or an intensity that is in a range defined by any two of the preceding values. For example, in some embodiments, the intensity of the light source is or can be adjustable between about 1-100, 1-75, 1-50, 1-25, 1-10, 1-5, 5-100, 5-75, 5-50, 5-25, 5-10, 10-100, 10-75, 10-50, 10-25, 25-100, 25-75, 25-50, 50-100, 50-75, or 75-100%, of the maximum intensity of the light source. In some embodiments, the light source illuminates a single sample. In some embodiments, the light source illuminates multiple samples. In some embodiments, the light source illuminates 1, 3, 5, 6, 10, 12, 18, 24, 25, 30, 36, 42, 48, 50, 54, 60, 66, 72, 75, 78, 84, 90, 96, 100, or 102, 114, 125, or 126 samples, or illuminates a number of samples that is in a range defined by any two of the preceding values. For example, in some embodiments, the light source illuminates between 1-126, 1-125, 1-100, 1-75, 1-50, 1-25, 1-10, 1-5, 5-125, 5-100, 5-75, 5-50, 5-25, 5-10, 10-125, 10-100, 10-75, 10-50, 10-25, 25-125, 25-100, 25-75, 25-50, 50-125, 50-100, 50-75, 75-125, 75-100, or 100-125 samples. In some embodiments, a light source, tube rack, and imaging station are modular components. In several embodiments, an imaging station further comprises means for imaging layered, gradated, or partitioned samples, for example, using a camera assembly 105. In some embodiments, a camera assembly is integrated into an imaging station. In some embodiments, a camera is integrated into a sample storage apparatus. In some embodiments, a camera assembly is a modular device. In some embodiments, data is saved locally on a control computer, in an integrated hard drive or data storage device, in an external hard drive or data storage device, in the cloud, or in any other means of data storage.

In several embodiments, an illuminated tube is positioned in front of a camera. A camera assembly captures an image of a sample within a sample storage apparatus and transmits an image to a controlling computer 106. In some embodiments, a controlling computer is integrated into a standalone unit with an imaging station, and collection apparatus. In some embodiments, an integrated system contains a graphical user interface or monitor. In some embodiments, an integrated device can wirelessly transmit images to an external computer or device. In several embodiments, an image of a sample is displayed to an operator. An operator then defines, or otherwise identifies or demarcates the boundaries of a sample to be collected by selecting the bottom and topmost points of the sample containing any material of interest. In some embodiments the image of the sample is or can be displayed to the operator along with a graded scale behind or next to the tube. In some embodiments, the graded scale assists the operator in defining an extraction boundary. In some embodiments, an operator defines an extraction boundary by manually entering the coordinates of material of interest into a control computer. In some embodiments, an operator defines an extraction boundary by boxing, circling, or otherwise drawing an extraction boundary. In some embodiments, the image is or can be processed, or image processing is or can be otherwise applied to images captured by an embodiment of the system. Processing of the image may comprise evaluating the intensity of each pixel in an image and assigning each pixel a value according to that intensity. The process may then comprise, evaluating the intensity of the pixels across any given height of the sample or sample collection container. An operator and/or computer, processor, or other suitable means or methods may then determine the extraction boundaries based on the intensity of the pixels at different heights in the sample image. A controlling computer then determines an extraction volume and needle 107 location based on a defined extraction boundary. In some embodiments, a sample image is saved. In some embodiments, a sample image with a defined extraction boundary is saved. In some embodiments, records of a defined extraction boundary, initial needle location, volume aspirated, and other data accumulated or generated during the extraction process are saved. In some embodiments, the evaluation of pixel intensity in the sample image is or can be saved.

A collection apparatus 107 comprises a collection arm 108 and a collection device 109. In some embodiments, a collection device comprises means for aspirating and/or dispensing extracted sample material. In some embodiments, means for aspirating and dispensing extracted material comprises a needle. In some embodiments, a needle is connected to a syringe or other means for aspirating material of interest from a sample and dispensing the material of interest into a sample collection vessel. In some embodiments, a collection device comprises a pipette. In some embodiments, a collection device is attached to a collection arm. In some embodiments, the collection device is removably attached to a collection arm. In some embodiments, a collection arm and collection device are integrated into a single collection apparatus. In some embodiments, a collection arm comprises mechanical means for allowing a collection device to move laterally along a length of the collection arm. A control computer 106 directs movement of a collection arm and collection device. The control computer directs movement of the collection apparatus to position the collection device at an appropriate sample extraction or sample dispensation location. A control computer directs movement of the collection apparatus between samples in a sample storage apparatus as well as between samples and a sample collection vessel 110. In some embodiments, a controlling computer directs a collection device to an appropriate location in a sample based on the defined extraction boundary. A calculated volume of sample is aspirated into a collection device. A controlling computer then directs a collection arm to orient the collection device within, or above, a sample collection vessel located at predetermined coordinates. Extracted material is then dispensed into a sample collection vessel. A controlling computer then directs a collection arm to place a collection device at an appropriate point in a second sample in a sample storage apparatus using a starting collection device depth and extraction volume that was calculated for extraction of material of interest from a first sample. In some embodiments, an operator can define different extraction boundaries for each sample, row of samples, or column of samples in a sample storage apparatus. In some embodiments, an operator can define different extraction volumes for each tube, row of tubes, or column of tubes contained within a sample storage apparatus. In some embodiments, the height and extraction speed are or can be adjusted to a specific height and extraction speed suitable for efficient extraction of the sample. In some embodiments, the extraction speed is about 1, 2, 3, 4, 5, 6, 7, 8, 9, 10, 20, 25, 30, 40, 50, 60, 70, 80, 90, 100, 150, 200, 250, 300, 400, 500, 600, 700, 750, 800, 900, or 1000 μL/s, or at a speed that is in a range defined by any two of the preceding values. For example, in some embodiments, the extraction speed is between about, 1-1000, 1-750, 1-500, 1-250, 1-100, 1-50, 1-25, 1-10, 10-1000, 10-750, 10-500, 10-250, 10-100, 10-50, 10-25, 25-1000, 25-750, 25-500, 25-250, 25-100, 25-50, 50-1000, 50-750, 50-500, 50-250, 50-100, 100-1000, 100-750, 100-500, 100-250, 250-1000, 250-750, 250-500, 500-1000, 500-750, or 750-1000 μL/s. In some embodiments, the extraction speed is about 0.001, 0.01, 0.1, 0.5, 1, 2, 3, 4, 5, 6, 7, 8, 9, 10, 15, 20, 25, 30, 35, 40, 45, 50, 60, 70, 75, 80, 90, or 100 mL/s, or an extraction speed that is defined by any two of the preceding values. For example, in some embodiments, the extraction speed is between about 0.001-100, 0.001-75, 0.001-50, 0.001-25, 0.001-10, 0.001-5, 0.001-1, 0.001-0.05, 0.001-0.01, 0.01-100, 0.01-75, 0.01-50, 0.01-25, 0.01-10, 0.01-5, 0.01-1, 1-100, 1-75, 1-50, 1-25, 1-10, 10-100, 10-75, 10-50, 10-25, 25-100, 25-75, 25-50, 50-100, 50-75, or 75-100 mL/s. In some embodiments, the extraction speed is about 1, 2, 3, 4, 5, 6, 7, 8, 9, 10, 20, 25, 30, 40, 50, 60, 70, 75, 80, 90, or 100%, of the maximum extraction speed of the extraction device, or a speed that is in a range defined by any two of the preceding values. For example, in some embodiments, the extraction speed is between about 1-100, 1-75, 1-50, 1-25, 1-10, 10-100, 10-75, 10-50, 10-25, 25-100, 25-75, 25-50, 50-100, 50-75, or 75-100%, of the maximum extraction speed of the extraction device. In some embodiments, the extraction speed is between 3-15 mL/min. In some embodiments, the aspiration rate is between 0.05-0.25 mL/second. In some embodiments, the aspiration rate is 1, 2, 3, 4, 5, 6, 7, 8, 9, 10, 11, 12, 13, 14, 15, 20, 25, 30, 35, 40, 45, 50 mL/min, or any value in between. In some embodiments, the extraction speed is between 0.01, 0.02, 0.03, 0.04, 0.05, 0.06, 0.07, 0.08, 0.09, 0.10, 0.15, 0.20, 0.25, 0.30, 0.35, 0.40, 0.50, 0.60, 0.70, 0.80, 0.90, 1.0, or any value in between, mL/second. In some embodiments, the extraction volume is the volume of the sample. In some embodiments, the extraction volume is between 5-15 mL. In some embodiments, the extraction volume is about 1, 2, 3, 4, 5, 6, 7, 8, 9, 10, 20, 25, 30, 40, 50, 60, 70, 80, 90, 100 mL, or at a volume that is in a range defined by any two of the preceding values. In some embodiments, the extraction volume is about 100, 150, 200, 250, 300, 400, 500, 600, 700, 750, 800, 900, or 1000 mL, or at a volume in a range defined by any two of the preceding values.

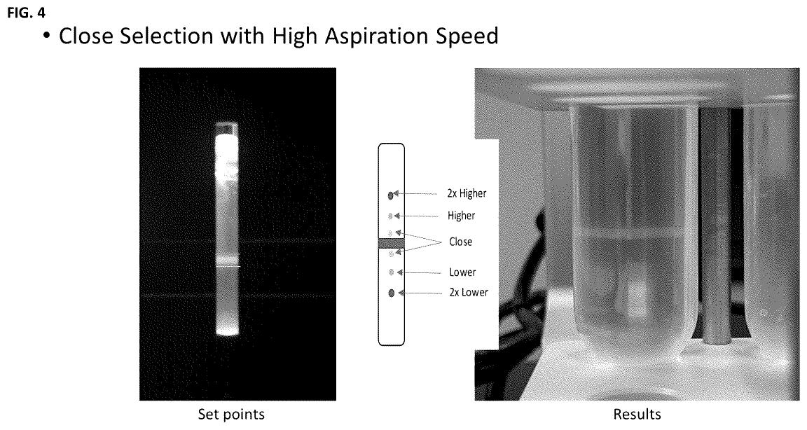

FIG. 4 is a non-limiting example of an image showing some embodiments of setpoints close to the desired extraction band (left) and the results of extraction at high aspiration rates (right).

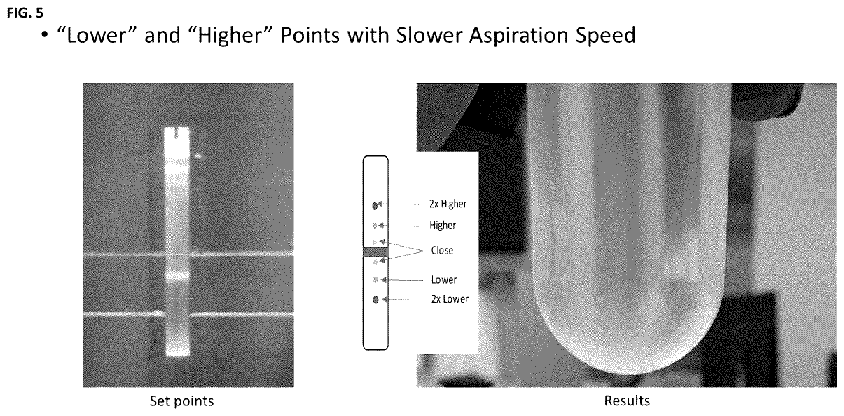

FIG. 5 is a non-limiting example of an image showing some embodiments of setpoints lower and higher than the desired extraction band (left) and the results of extraction at slow aspiration rates (right).

In some embodiments, the aspiration speed and needle height are or can be determined based on their suitability for extraction of a desired material. For example, in some embodiments, the needle can or will be positioned close to the desired extraction material and the aspiration rate can or will be lowered or raised for extraction of the material from this height.

### Automated Extraction

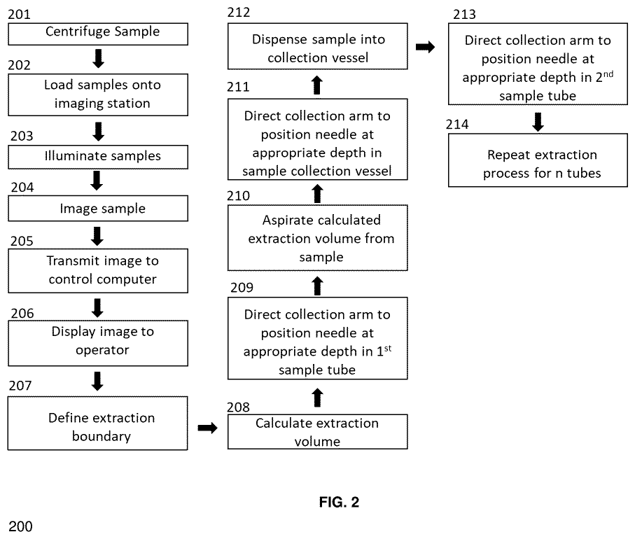

FIG. 2 illustrates a flow chart of a non-limiting example process 200 for automated extraction of material from layered, gradated, or partitioned samples.

At block 201, samples to be layered, gradated, or partitioned, including for example samples containing a mixture of DNA-containing and empty viral particles, are layered, gradated, or partitioned, via gradient ultracentrifugation. Following centrifugation, at block 202, the samples are loaded onto an imaging station. In some embodiments, samples are loaded onto an imaging station by an operator. In some embodiments, samples are loaded onto an imaging station by an automated device. In some embodiments, samples loading is or can be predefined by an operator, and samples are or can be loaded by an automated device. Once one, some, or all samples are loaded, a first sample is illuminated at block 203. At block 204, an image of the first sample within the sample storage apparatus can be captured. A first sample image is then transmitted to a controlling computer at block 205. In some embodiments, a sample image is transmitted wirelessly. In some embodiments, a sample image is transmitted to a control computer via physical means. A control computer displays one or more sample images at block 206 to an operator who defines an extraction boundary at block 207. For example, by selecting the bottom-most and top-most points of a layer, gradation, or partition to be collected from a sample. A control computer uses operator provided information to calculate a volume that is to be extracted at block 208, the volume can be determined by defining a set of coordinates for collection device placement for extraction of an identified layer, gradation, or partition from a layered, gradated, or partitioned sample. A control computer then directs a collection arm at block 209 comprising a collection device, for example a needle and syringe, such that the needle is positioned at previously determined extraction coordinates. A calculated extraction volume is then aspirated at block 210 from a sample, the extracted volume containing material of interest, for example DNA-containing viral particles (as opposed to empty viral particles). Following extraction of material of interest from a sample, e.g., a layered, gradated, or partitioned sample, a control computer directs a collection arm to position a collection device at an appropriate point above or within a sample collection vessel at block 211 for dispensing an extracted sample into the sample collection vessel. Once properly aligned with a sample collection vessel, a control computer then directs dispensation at block 212 of extracted material into the vessel. A control computer then directs movement of a collection arm to position a collection device above a second sample in a sample storage apparatus at block 213. The sample extraction process is repeated for one or more additional samples using a collection device position within each additional sample and sample extraction volume that was originally calculated for a first sample at block 214.

In some embodiments, the light source illuminates a sample intermittently. In some embodiments, the intensity of the light source is or can be adjustable. For example, in some embodiments, the intensity of a light source may be adjusted to emit light at an intensity of about 1, 2, 3, 4, 5, 6, 7, 8, 9, 10, 20, 25, 30, 40, 50, 60, 70, 75, 80, 90, 95, or 100%, of the maximum intensity of the light source, or an intensity that is in a range defined by any two of the preceding values. For example, in some embodiments, the intensity of the light source is adjustable between about 1-100, 1-75, 1-50, 1-25, 1-10, 1-5, 5-100, 5-75, 5-50, 5-25, 5-10, 10-100, 10-75, 10-50, 10-25, 25-100, 25-75, 25-50, 50-100, 50-75, or 75-100%, of the maximum intensity of the light source. In some embodiments, the light source illuminates a single sample. In some embodiments, the light source illuminates multiple samples. In some embodiments, the light source illuminates 1, 3, 5, 6, 10, 12, 18, 24, 25, 30, 36, 42, 48, 50, 54, 60, 66, 72, 75, 78, 84, 90, 96, 100, or 102, 114, 125, or 126 samples, or illuminates a number of samples that is in a range defined by any two of the preceding values. For example, in some embodiments, the light source illuminates between 1-126, 1-125, 1-100, 1-75, 1-50, 1-25, 1-10, 1-5, 5-125, 5-100, 5-75, 5-50, 5-25, 5-10, 10-125, 10-100, 10-75, 10-50, 10-25, 25-125, 25-100, 25-75, 25-50, 50-125, 50-100, 50-75, 75-125, 75-100, or 100-125 samples. In some embodiments, a new extraction boundary and extraction volume is defined for each sample. In some embodiments, the extraction boundary and volume for extraction of a specific sample may be determined and saved as a protocol for use in extracting subsequent volumes from tubes containing samples of the same type. For example, in some embodiments, the extraction boundary and extraction volume for extraction of a capsid from a 40 mL volume in a 50 mL tube may be determined for a control sample. These values may then be saved for later use in extracting capsids from other tubes of the same size and volume. In some embodiments, a different program for each different species to be extracted can be predetermined and saved. In some embodiments, the height and extraction speed are adjusted to a specific height and extraction speed suitable for efficient extraction of the sample. In some embodiments, the extraction speed is about 1, 2, 3, 4, 5, 6, 7, 8, 9, 10, 20, 25, 30, 40, 50, 60, 70, 80, 90, 100, 150, 200, 250, 300, 400, 500, 600, 700, 750, 800, 900, or 1000 μL/s, or at a speed that is in a range defined by any two of the preceding values. For example, in some embodiments, the extraction speed is between about, 1-1000, 1-750, 1-500, 1-250, 1-100, 1-50, 1-25, 1-10, 10-1000, 10-750, 10-500, 10-250, 10-100, 10-50, 10-25, 25-1000, 25-750, 25-500, 25-250, 25-100, 25-50, 50-1000, 50-750, 50-500, 50-250, 50-100, 100-1000, 100-750, 100-500, 100-250, 250-1000, 250-750, 250-500, 500-1000, 500-750, or 750-1000 L/s. In some embodiments, the extraction speed is about 0.001, 0.01, 0.1, 0.5, 1, 2, 3, 4, 5, 6, 7, 8, 9, 10, 15, 20, 25, 30, 35, 40, 45, 50, 60, 70, 75, 80, 90, or 100 mL/s, or an extraction speed that is defined by any two of the preceding values. For example, in some embodiments, the extraction speed is between about 0.001-100, 0.001-75, 0.001-50, 0.001-25, 0.001-10, 0.001-5, 0.001-1, 0.001-0.05, 0.001-0.01, 0.01-100, 0.01-75, 0.01-50, 0.01-25, 0.01-10, 0.01-5, 0.01-1, 1-100, 1-75, 1-50, 1-25, 1-10, 10-100, 10-75, 10-50, 10-25, 25-100, 25-75, 25-50, 50-100, 50-75, or 75-100 mL/s. In some embodiments, the extraction speed is about 1, 2, 3, 4, 5, 6, 7, 8, 9, 10, 20, 25, 30, 40, 50, 60, 70, 75, 80, 90, or 100%, of the maximum extraction speed of the extraction device, or a speed that is in a range defined by any two of the preceding values. For example, in some embodiments, the extraction speed is between about 1-100, 1-75, 1-50, 1-25, 1-10, 10-100, 10-75, 10-50, 10-25, 25-100, 25-75, 25-50, 50-100, 50-75, or 75-100%, of the maximum extraction speed of the extraction device.

### Computer System

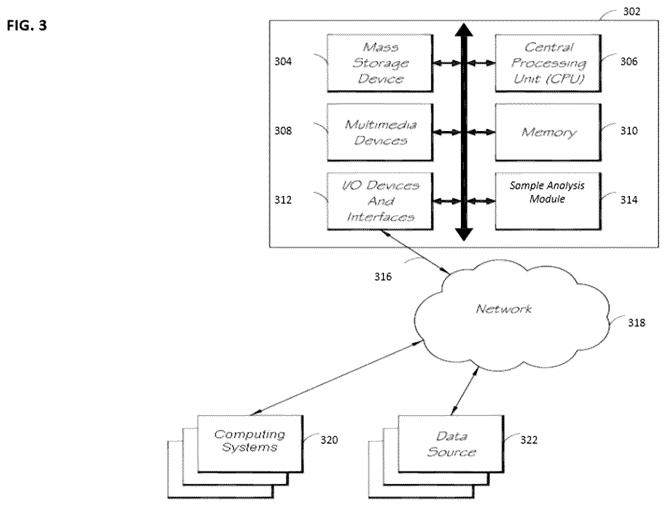

In some embodiments, the systems, processes, and methods described herein are implemented using a computing system, such as the one illustrated in FIG. 3. The example computer system 302 is in communication with one or more computing systems 320 and/or one or more data sources 322 via one or more networks 318. While FIG. 3 illustrates an embodiment of a computing system 302, it is recognized that the functionality provided for in the components and modules of computer system 302 can be combined into fewer components and modules, or further separated into additional components and modules.

The computer system 302 can comprise a sample analysis module 314 that carries out the functions, methods, acts, and/or processes described herein. The sample analysis module 314 is executed on the computer system 302 by a central processing unit 306 discussed further below.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems and can be stored on or within any suitable computer readable medium or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

### Computing System Components

The computer system 302 includes one or more processing units (CPU) 306, which can comprise a microprocessor. The computer system 302 further includes a physical memory 310, such as random access memory (RAM) for temporary storage of information, a read only memory (ROM) for permanent storage of information, and a mass storage device 304, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. Typically, the components of the computer system 302 are connected to the computer using a standards based bus system. The bus system can be implemented using various protocols, such as Peripheral Component Interconnect (PCI), Micro Channel, SCSI, Industrial Standard Architecture (ISA) and Extended ISA (EISA) architectures.

The computer system 302 includes one or more input/output (I/O) devices and interfaces 312, such as a keyboard, mouse, touch pad, and printer. The I/O devices and interfaces 312 can include one or more display devices, such as a monitor, which allows the visual presentation of data to a user. More particularly, a display device provides for the presentation of GUIs as application software data, and multi-media presentations, for example. The I/O devices and interfaces 312 can also provide a communications interface to various external devices. The computer system 302 can comprise one or more multi-media devices 308, such as speakers, video cards, graphics accelerators, and microphones, for example.

### Computing System Device/Operating System

The computer system 302 can run on a variety of computing devices, such as a server, a Windows server, a Structure Query Language server, a Unix Server, a personal computer, a laptop computer, and so forth. In other embodiments, the computer system 302 can run on a cluster computer system, a mainframe computer system and/or other computing system suitable for controlling and/or communicating with large databases, performing high volume transaction processing, and generating reports from large databases. The computing system 302 is generally controlled and coordinated by an operating system software, such as z/OS, Windows, Linux, UNIX, BSD, PHP, SunOS, Solaris, MacOS, iCloud services or other compatible operating systems, including proprietary operating systems. Operating systems control and schedule computer processes for execution, perform memory management, provide file system, networking, and I/O services, and provide a user interface, such as a graphical user interface (GUI), among other things.

### Network

The computer system 302 illustrated in FIG. 3 is coupled to a network 318, such as a LAN, WAN, or the Internet via a communication link 316 (wired, wireless, or a combination thereof). Network 318 communicates with various computing devices and/or other electronic devices. Network 318 is communicating with one or more computing systems 320 and one or more data sources 222. The sample analysis module 314 can access or can be accessed by computing systems 320 and/or data sources 322 through a web-enabled user access point. Connections can be a direct physical connection, a virtual connection, and other connection type. The web-enabled user access point can comprise a browser module that uses text, graphics, audio, video, and other media to present data and to allow interaction with data via the network 318.

The output module can be implemented as a combination of an all-points addressable display such as a cathode ray tube (CRT), a liquid crystal display (LCD), a plasma display, or other types and/or combinations of displays. The output module can be implemented to communicate with input devices 312 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module can communicate with a set of input and output devices to receive signals from the user.

### Other Systems

The computing system 302 can include one or more internal and/or external data sources (for example, data sources 322). In some embodiments, one or more of the data repositories and the data sources described above can be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 302 can also access one or more databases 322. The databases 322 can be stored in a database or data repository. The computer system 302 can access the one or more databases 322 through a network 318 or can directly access the database or data repository through I/O devices and interfaces 312. The data repository storing the one or more databases 322 can reside within the computer system 302.

### Numbered Arrangements:

Some embodiments provided herein are described by way of the following provided numbered arrangements and also provided as possible combinations or overlapping embodiments:
1. An automated liquid handling system, comprising:
   an imaging station; and
   a collection apparatus,
   wherein the imaging station is configured to image a sample and transmit a sample image to a control computer,
   wherein the imaging station and the collection apparatus are operably linked to the control computer,
   wherein the control computer is configured to process the sample image, and
   wherein the collection apparatus transfers a defined extraction volume from the sample to a sample collection vessel.
2. The automated liquid handling system of arrangement 1, wherein the control computer is configured to define one or more extraction points from the sample.
3. The automated liquid handling system of arrangement 1, wherein the intensity of the light source corresponds to the specific opacity of the sample storage apparatus.
4. The automated liquid handling system of arrangement 1, wherein the intensity of the light source is adjustable.
5. The automated liquid handling system of arrangement 1, wherein the light source is located above, below, or oblique to the sample storage apparatus.
6. The automated liquid handling system of arrangement 1, wherein the defined extraction volume is between about 0 and 50 mL.
7. The automated liquid handling system of arrangement 1, wherein the system is configured to extract the defined extraction volume at an extraction rate between about 0.001 and 25 mL/s.
8. The automated liquid handling system of arrangement 1, wherein the imaging device comprises a camera.
9. The automated liquid handling system of arrangement 1, wherein the system is configured to run an extraction program for extraction of a desired fraction from a sample.
10. The automated liquid handling system of arrangement 1, wherein the imaging station and collection apparatus are stand-alone components.
11. The automated liquid handling system of arrangement 1, wherein the imaging station and collection apparatus are integrated into a single system.
12. The automated liquid handling system of arrangement 1, wherein one or more of the imaging station, collection apparatus, and control computer are stand-alone components.
13. The automated liquid handling system of arrangement 1, wherein one or more of the imaging station, collection apparatus, and control computer are integrated into a single system.
14. The automated liquid handling system of arrangement 1, wherein the imaging station comprises a sample storage apparatus, a light source, and an imaging device.
15. The automated liquid handling system of arrangement 1, wherein the sample storage apparatus, light source, and imaging device are integrated into a single imaging station.
16. The automated liquid handling system of arrangement 1, wherein the sample storage apparatus comprises a tube rack.
17. The automated liquid handling system of arrangement 1, wherein the sample storage apparatus comprises a multi-well plate rack.
18. The automated liquid handling system of arrangement 1, wherein the sample storage apparatus has a specific opacity.
19. The automated liquid handling system of arrangement 1, wherein the light source is located above the sample storage apparatus.
20. The automated liquid handling system of arrangement 1, wherein the light source is located below the sample storage apparatus.
21. The automated liquid handling system of arrangement 1, wherein the light source is located oblique to the sample storage apparatus.
22. The automated liquid handling system of arrangement 1, wherein the light source, light source position, and sample storage apparatus opacity are collectively chosen for their combined suitability for imaging samples contained in the sample storage apparatus.
23. The automated liquid handling system of arrangement 1, further comprising a graphical user interface that is operably linked to the control computer.
24. The automated liquid handling system of arrangement 1, wherein a collection apparatus comprises a collection arm and a collection device.
25. The automated liquid handling system of arrangement 1, wherein the collection device is removably attached to the collection arm.
26. The automated liquid handling system of arrangement 1, wherein the control computer is configured to direct movement of the collection device laterally, horizontally, and/or vertically along a collection arm.
27. The automated liquid handling system of arrangement 1, wherein the collection arm is configured such that it may be directed by the control computer to move in an x, y, and/or z directions.
28. The automated liquid handling system of arrangement 1, wherein the light source is integrated into the collection arm.
29. The automated liquid handling system of arrangement 1, wherein the control computer is configured to direct the control arm to position the collection device at predetermined and/or operator determined extraction coordinates.
30. The automated liquid handling system of arrangement 1, wherein the collection device comprises means for sample transfer from the sample storage apparatus to the sample collection vessel.
31. The automated liquid handling system of arrangement 1, wherein the collection device comprises a pipette.
32. The automated liquid handling system of arrangement 1, wherein the collection device comprises a needle and syringe.
33. The automated liquid handling system of arrangement 1, wherein one or more of the imaging station, collection apparatus, collection vessel, or control computer are integrated into a single functional system.
34. The automated liquid handling system of arrangement 1, further comprising a tip rack.
35. The automated liquid handling system of arrangement 1, further comprising a tip disposal vessel.
36. The automated liquid handling system of any one of the preceding arrangements, wherein the imaging station and collection apparatus are integrated into a single system.
37. The automated liquid handling system of any one of the preceding arrangements, wherein one or more of the imaging station, collection apparatus, and control computer are stand-alone components.
38. The automated liquid handling system of any one of the preceding arrangements, wherein one or more of the imaging station, collection apparatus, and control computer are integrated into a single system.
39. The automated liquid handling system of any one of the preceding arrangements, wherein the imaging station comprises a sample storage apparatus, a light source, and an imaging device.
40. The automated liquid handling system of any one of the preceding arrangements, wherein the sample storage apparatus, light source, and imaging device are integrated into a single imaging station.
41. The automated liquid handling system of any one of the preceding arrangements, wherein the sample storage apparatus comprises a tube rack.
42. The automated liquid handling system of any one of the preceding arrangements, wherein the sample storage apparatus comprises a multi-well plate rack.
43. The automated liquid handling system of any one of the preceding arrangements, wherein the sample storage apparatus has a specific opacity.
44. The automated liquid handling system of any one of the preceding arrangements, wherein the light source is located above the sample storage apparatus.
45. The automated liquid handling system of any one of the preceding arrangements, wherein the light source is located below the sample storage apparatus.
46. The automated liquid handling system of any one of the preceding arrangements, wherein the light source is located oblique to the sample storage apparatus.
47. The automated liquid handling system of any one of the preceding arrangements, wherein the light source, light source position, and sample storage apparatus opacity are collectively chosen for their combined suitability for imaging samples contained in the sample storage apparatus.
48. The automated liquid handling system of any one of the preceding arrangements, further comprising a graphical user interface that is operably linked to the control computer.
49. The automated liquid handling system of any one of the preceding arrangements, wherein a collection apparatus comprises a collection arm and a collection device.
50. The automated liquid handling system of any one of the preceding arrangements, wherein the collection device is removably attached to the collection arm.
51. The automated liquid handling system of any one of the preceding arrangements, wherein the control computer directs movement of the collection device laterally, horizontally, and/or vertically along a collection arm.
52. The automated liquid handling system of any one of the preceding arrangements, wherein the collection arm is configured such that it may be directed by the control computer to move in an x, y, and/or z directions.
53. The automated liquid handling system of any one of the preceding arrangements, wherein the light source is integrated into the collection arm.
54. The automated liquid handling system of any one of the preceding arrangements, wherein the control computer directs the control arm to position the collection device at predetermined and/or operator determined extraction coordinates.
55. The automated liquid handling system of any one of the preceding arrangements, wherein the collection device comprises means for sample transfer from the sample storage apparatus to the sample collection vessel.
56. The automated liquid handling system of any one of the preceding arrangements, wherein the collection device comprises a pipette.
57. The automated liquid handling system of any one of the preceding arrangements, wherein the collection device comprises a needle and syringe.
58. The automated liquid handling system of any one of the preceding arrangements, wherein one or more of the imaging station, collection apparatus, collection vessel, or control computer are integrated into a single functional system.
59. The automated liquid handling system of any one of the preceding arrangements, further comprising a tip rack.
60. The automated liquid handling system of any one of the preceding arrangements, further comprising a tip disposal vessel.
61. A method for automated extraction of material from a sample, comprising:
   a. loading a sample onto an imaging station,
   b. illuminating the sample,
   c. imaging the illuminated sample,
   d. transmitting a sample image to a control computer,
   e. calculating an extraction volume and extraction coordinates based on the sample image,
   f. directing a collection arm to orient a collection device at the calculated extraction coordinates,
   g. aspirating a calculated extraction volume from the sample into the collection device,
   h. directing the collection arm to orient the collection device to a collection vessel that is located at predetermined coordinates and dispensing an extracted volume into the collection vessel.
62. The method of arrangement 61, further comprising repeating steps a through h for each of n samples; wherein n is a non-negative integer.
63. A method for automated extraction of material from a sample, comprising:
   a. loading one or more sample(s) onto an imaging station,
   b. illuminating the one or more sample(s) to generate one or more illuminated sample(s),
   c. imaging the one or more illuminated sample(s),
   d. transmitting one or more sample image(s) to a control computer,
   e. calculating an extraction volume and extraction coordinates based on the sample image,
   f. directing a collection arm to orient a collection device at the calculated extraction coordinates,
   g. aspirating an extraction material based on the calculated extraction volume from the one or more sample(s) into a collection device,
   h. directing the collection arm to orient the collection device to one or more collection vessel(s), and
   i. dispensing the extraction material into the one or more collection vessel(s).
64. The method of arrangement 63, further comprising repeating steps b through h for each sample within the one or more sample(s).
65. The method of arrangement 63, further comprising acquiring a pipette tip prior to sample aspiration.
66. The method of arrangement 63, further comprising discarding used tips following dispensation of the extracted sample volume into the collection device.
67. The method of arrangement 63, wherein calculating an extraction volume and extraction coordinates based on the sample image comprises: defining an extraction boundary.
68. The method of arrangement 63, wherein defining the extraction boundary is performed by the control computer.
69. The method of arrangement 63, further comprising centrifuging the sample prior to loading onto the imaging station.
70. The method of arrangement 63, wherein the sample comprises a layered, gradated, or partitioned sample.
71. The method of any one of arrangements 63-70, wherein the extracted material comprises one layer, gradation, or partition of a layered, gradated, or partitioned, sample.
72. The method of any one of arrangements 63-70, wherein the operator is a computer program.
73. The method of any one of arrangements 63-70, wherein the operator is a human.
74. The method of any one of arrangements 63-70, further comprising centrifuging each sample comprising the one or more sample(s) prior to loading.
75. The method of any one of arrangements 63-70, wherein the one or more sample(s) comprises a layered, gradated, or partitioned sample.
76. The method of any one of arrangements 63-70, wherein the extracted material comprises one layer, gradation, or partition of a layered, gradated, or partitioned sample.
77. The method of any one of arrangements 63-70, wherein the extraction boundary is defined by an operator.

### EXAMPLES

### Example 1—Capsid Recovery

The efficiency of capsid extraction from tubes having different set points and aspiration speeds was evaluated. Tubes comprising capsid at the same viral load and subjected to the same spin conditions were prepared with either 1.3142 (test conditions 1, 3, 4, 6, 7), 1.5227 (test conditions 9 and 10, “High Density”), or 1.1720 (test condition 11 and 12, “Low Density”) g/mL CsCl. and loaded on the automated liquid handling device.

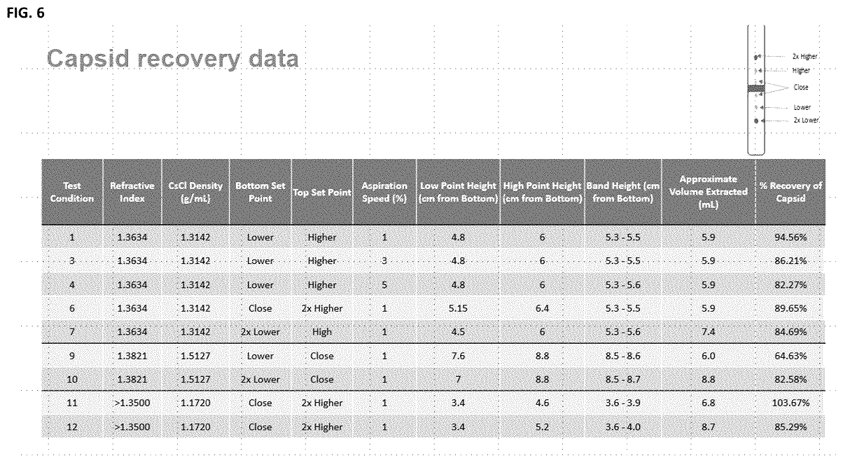

FIG. 6 is a table showing some embodiments of capsid recovery from tubes with different set heights and aspiration rates.

Test conditions 1, 3, 4, describe capsid from tubes having the same CsCl concentration and set points was extracted from each tube at a different aspiration rate (1%, 3%, and 5%, of max aspiration rate respectively). Test conditions 6 and 7 describe capsid recovery from tubes having the same CsCl concentration and aspiration rate (1% of max aspiration rate), but different set points. Test conditions 9 and 10 describe capsid recovery from tubes having the same CsCl concentration and aspiration rate (1% of max aspiration rate), but different set points (low or lower, and close). Test conditions 11 and 12 tested different extraction volumes (6.8 and 8.7 mL respectively).

As shown from FIG. 6, capsid is recovered at an efficiency between 82 and 105% at a variety of combinations of aspiration speed and set points. Moreover, results indicated capsid recovery at varying CsCl concentrations.

In the foregoing description, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein. Overall, the language of the claims is to be interpreted broadly based on the language employed in the claims. The claims are not to be limited to the non-exclusive embodiments and examples that are illustrated and described in this disclosure, or that are discussed during the prosecution of the application.

Those skilled in the art will also appreciate that in some embodiments the functionality provided by the components, structures, methods and processes discussed above may be provided in alternative ways, such as being split among more components or methods or consolidated into fewer components or methods. In addition, while various methods may be illustrated as being performed in a particular order, those skilled in the art will appreciate that in other embodiments the methods may be performed in other orders and in other manners.

Also, although there may be some embodiments within the scope of this disclosure that are not expressly recited above or elsewhere herein, this disclosure contemplates and includes all embodiments within the scope of what this disclosure shows and describes. Further, this disclosure contemplates and includes embodiments comprising any combination of any structure, material, step, or other feature disclosed anywhere herein with any other structure, material, step, or other feature disclosed anywhere herein.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while components and operations may be depicted in the drawings or described in the specification in a particular arrangement or order, such components and operations need not be arranged and performed in the particular arrangement and order shown, nor in sequential order, nor include all of the components and operations, to achieve desirable results. Other components and operations that are not depicted or described can be incorporated in the embodiments and examples. For example, one or more additional operations can be performed before, after, simultaneously, or between any of the described operations. Further, the operations may be rearranged or reordered in other implementations. Also, the separation of various system components in the implementations described above should not be understood as requiring such separation in all implementations, and it should be understood that the described components and systems can generally be integrated together in a single product or packaged into multiple products.

In summary, various illustrative embodiments and examples of a machine, device, process, and method for automated extraction of material from layered, gradated, or partitioned samples have been disclosed. Although the systems, techniques, and methods have been disclosed in the context of those embodiments and examples, this disclosure extends beyond the specifically disclosed embodiments to other alternative embodiments and/or other uses of the embodiments, as well as to certain modifications and equivalents thereof. This disclosure expressly contemplates that various features and aspects of the disclosed embodiments can be combined with, or substituted for, one another. Accordingly, the scope of this disclosure should not be limited by the particular disclosed embodiments described above but should be determined only by a fair reading of the claims that follow as well as their full scope of equivalents.

What is claimed is:

1. An automated liquid handling system, comprising:
an imaging station; and
a collection apparatus,
wherein the imaging station is configured to image a sample and transmit a sample image to a control computer,
wherein the imaging station and the collection apparatus are operably linked to the control computer,
wherein the control computer is configured to process the sample image, and
wherein the collection apparatus transfers a defined extraction volume from the sample to a sample collection vessel.
